(19) United States
(12) Patent Application Publication
(10) Pub. No.: US 2014/0355574 A1
(43) Pub. Date: Dec. 4, 2014

(54) Method, Apparatus and Computer Program for Scheduling Device-to-Device Signals

(71) Applicant: Broadcom Corporation, Irvine, CA (US)

(72) Inventors: Samuli TURTINEN, Ii (FI); Sami-Jukka HAKOLA, Kempele (FI); Timo Kalevi KOSKELA, Oulu (FI)

(73) Assignee: Broadcom Corporation, Irvine, CA (US)

(21) Appl. No.: 14/291,063

(22) Filed: May 30, 2014

(30) Foreign Application Priority Data
May 30, 2013 (GB) 1309707.6

(51) Int. Cl. H04W 72/12; H04W 56/00; H04W 8/00

(52) U.S. Cl. CPC H04W 72/1278; H04W 8/005; H04W 56/00
USPC 370/336

(57) ABSTRACT

A method of operating a network control apparatus in which the network control apparatus is wirelessly connected to at least one wireless device. In the method, the network control apparatus indicates a device-to-device timing advance value to said wireless device. The device-to-device timing advance value is for use by the wireless device in scheduling the transmission of a device-to-device signal to a second wireless device.

### TECHNICAL FIELD

The present disclosure relates to a method, apparatus and computer program for scheduling device-to-device signals.

### BACKGROUND

The following abbreviations, which may be found in the specification and/or the drawing figures, are defined as follows:

CE control element

D2D device-to-device

dTAG D2D Timing Advance Group

eNB, eNodeB evolved Node B base station in an E-UTRAN System

LTE Long Term Evolution

LTE-A Long Term Evolution Advanced

MAC medium access control

RRC radio resource control

Rx reception, receiver

TA timing advance

TAG timing advance group

Tx transmission, transmitter

UE User equipment

UMTS Universal Mobile Telecommunications System

Cellular networks provide many services to users. In particular, they facilitate communication between devices. Since the initial release of cellular wireless devices, the number and capability of wireless devices has increased, and this trend is continuing. As a result, the burden on such cellular networks has also increased, and resources are becoming more and more stretched.

Devices have transmitting and receiving capability which enables them to communicate with cellular networks, but these capabilities can, and in some cases already have, been adapted for direct device-to-device communication. Direct device-to-device communication can provide a number of services to users without burdening network infrastructure such as base stations, etc. In addition, to the extent that device-to-device communication can be conducted on frequencies other than licensed network frequencies, it reduces the load on those licensed network frequencies.

Device-to-device communication might be particularly useful in reducing the burden on cellular networks in the exchange of audio and video materials (e.g. photos, user videos, voice and music) between devices. As another example, players in device-to-device range of one another might play in a multiplayer game, with game data being communicated directly between devices. Other players who were not in direct communication range could play using ordinary network communication, and the network load would be reduced through the ability of some or all of the players to communicate directly. Networks could conserve resources by offloading network communication to device-to-device communication, and machine to machine communication could be conducted directly.

### BRIEF DESCRIPTION OF THE DRAWINGS

FIG. 1 shows schematically an example prior art cellular communication system;

FIG. 2 shows schematically an example of an environment in which embodiments of the present disclosure may be practised;

FIG. 3 shows schematically an example timing diagram for the transmission of device-to-device discovery signals according to an embodiment of the present disclosure; and,

FIG. 4 shows schematically another example of an environment in which embodiments of the present disclosure may be practised.

### DETAILED DESCRIPTION

According to a first aspect of the present disclosure, there is provided a method of operating a network control apparatus, the network control apparatus being wirelessly connected to at least one wireless device, the method comprising: the network control apparatus indicating a device-to-device timing advance value to said wireless device, the device-to-device timing advance value being for use by the wireless device in scheduling the transmission of a device-to-device signal to a second wireless device.

In some example versions of the present disclosure, the device-to-device timing advance value is a value that may enable the first device to account or allow for the time taken for a signal to propagate from the first device to the second device when scheduling the transmission of the device-to-device signal, at least to some degree. Propagation delay between devices can be problematic because it may lead to signals being received by a device at unexpected (and often unwanted) times, which may in turn lead to interference between those signals and other signals received by the device. This can cause important data to be lost. The present disclosure provides a method by which the first device can account for propagation delay when scheduling the transmission of the device-to-device signal, and thus interference between the device-to-device signal and other signals received by the second device can be eliminated, or at least minimised, even if the distance between the first device and the second device is large. In one example, the device-to-device timing advance value may tell the first device how far in advance of a particular time (such as the beginning of a timeslot) the first device should transmit the device-to-device signal so as to avoid interference with other signals. The present disclosure is of particular use where the first device makes use of a licensed spectrum, as will become apparent in the following description.

Alternatively or additionally, the device-to-device timing advance value may be a value that enables the first device to account or allow for any asynchronicity between the first device and other devices. This may be useful where, for example, the first device is synchronised with a first access node (or more specifically, a channel of a first access node), and a second device is synchronised with a second access node (or more specifically, a channel of a second access node). The device-to-device timing advance value can, for example, be set such that the first device is caused to transmit a device-to-device signal at the same time as the second device transmits a device-to-device signal. This is advantageous in the case of device-to-device discovery signals, as it is advantageous for multiple devices to transmit discovery signals simultaneously.

In one example arrangement, the network control apparatus may indicate a plurality of device-to-device timing advance values to the first wireless device. Each device-to-device timing advance value may be for use by the first device in scheduling the transmission of signals to one or more other wireless devices. Thus, the first wireless device may be able to transmit device-to-device signals to a plurality of devices concurrently.

Furthermore, in one example arrangement, each device-to-device timing advance value may be at least one of: (i) for use within a particular geographic area and (ii) for use on a particular channel.

In one example arrangement, at least two of said plurality of device-to-device timing advance values are for use in scheduling the transmission of periodic device-to-device discovery signals, one of said at least two device-to-device timing advance values being associated with a first device-to-device discovery signal periodicity, and another of said at least two device-to-device timing advance values being associated with a second device-to-device discovery signal periodicity.

In the above arrangement, the network control apparatus may indicate said first and second associated periodicities to the first wireless device. The network is thereby able to coordinate device-to-device discovery signal transmissions from a plurality of wireless devices at once, and thereby prevent, or at least minimise, interference between those discovery signals.

The number of device-to-device timing advance values indicated to the first device may, in one example arrangement, be dependent upon timing advance capacity information received from the first wireless device. The timing advance capacity information could include the total number of timing advance values the first device can support, and/or the bands the first device can support.

In an embodiment, at least one device-to-device timing advance value may be indicated to the first wireless device via dedicated signalling between the network control apparatus and the first wireless device. The device-to-device timing advance value may be indicated in RRC signalling, for example. This allows the network control apparatus to set device-to-device timing advance values for the first device, which may be different from device-to-device timing advance values with which other wireless devices are configured.

Additionally, or alternatively, the network control apparatus may be wirelessly connected to a plurality of wireless devices and at least one device-to-device timing advance value may be indicated to at least some of said wireless devices via common signalling. The device-to-device timing advance value may be indicated in System Information, for example. This has the advantage that, if the network determines that a plurality of wireless devices need to be configured with a particular one device-to-device timing advance value, the network need only send a single message commonly to those devices.

Further to the above, the network control apparatus may be wirelessly connected to a plurality of wireless devices, said plurality of wireless devices forming a device-to-device timing advance group, the method may comprise indicating a common device-to-device timing advance value to said plurality of wireless devices. The wireless devices making up a timing advance group may, for example, all be configured to transmit device-to-device discovery signals with the same periodicity, or as another example, may all be located within the same geographic area (such as cell, discovery area or the like).

In one example arrangement, said network control apparatus may provide control for a wireless network and the first wireless device may be configured with one or more network timing advance values for use in scheduling uplink transmissions to the network. The device-to-device timing advance value, in this arrangement, is dependent upon the values of said one or more network timing advance values. As an example, the value of the device-to-device timing advance value may be conditional on the value of at least one network timing advance value such that the device-to-device timing advance value takes a first value unless the difference between that value and the cellular TA value exceeds a maximum value, in which case, the device-to-device timing advance value takes a value as close as possible to the first value without the maximum difference being exceeded.

In one example arrangement, said device-to-device timing advance value is for use by the first wireless device in scheduling the transmission of a plurality of signals to other wireless devices, said plurality of transmissions taking place within a predetermined period of time. The network control apparatus may indicate to the first device the period of time for which the device-to-device timing advance value can be used. As is known in the art, some wireless devices are subject to clock drift. As will be appreciated, for such devices, the suitability of a device-to-device timing advance value will decrease with time, as the clock of the wireless device drifts. It may be useful to configure such a device with device-to-device timing advance values that “expire” after a predetermined period, such that the suitability of a given device-to-device timing advance value does not depreciate beyond a certain point as a result of clock drift. Upon expiration of a device-to-device timing advance value, a wireless device may be required to “re-synchronise” by being reconfigured with a new device-to-device timing advance value, which takes into account the amount by which the clock of the wireless device has drifted since the last device-to-device timing advance value was configured. In one example version of the disclosure, the wireless device may store expired device-to-device timing advance values. In this case, if the network may determine that an expired device-to-device timing advance value is still suitable, it may indicate to the wireless device that it should re-use the expired value.

In one particular example arrangement, the network control element is part of an LTE network provided by an eNB.

According to a second aspect of the present disclosure, there is provided apparatus including a processing system for a network control apparatus, the apparatus being constructed and arranged to cause a said network control apparatus to: indicate a device-to-device timing advance value to a first wireless device wirelessly connected to the network control apparatus, the device-to-device timing advance value being for use by said first wireless device in scheduling the transmission of a device-to-device signal to a second wireless device. The processing system may include at least one processor and at least one memory including computer program instructions, the at least one memory and the computer program instructions being configured, with the at least one processor, to cause the network control apparatus at least to perform a method as described above.

According to a third aspect of the present disclosure, there is provided a computer program comprising instructions such that when the computer program is executed on a user equipment, the user equipment is arranged to carry out a method as described above. There may be provided a non-transitory computer-readable storage medium storing a computer program as described above.

According to a fourth aspect of the present disclosure, there is provided a method of operating a wireless device, the method comprising: the wireless device scheduling the transmission of a device-to-device signal to a second wireless device according to a device-to-device timing advance value.

In one example arrangement, the timing advance value may be received from a cellular network control apparatus, which provides cellular network service for said wireless device. This has the advantage that the cellular network is able to control the timing of device-to-device transmissions from the first device, and is therefore able to coordinate the transmission of those device-to-device signals with the transmissions of other signals sent by other wireless devices, and also signals sent by the cellular network, so as to minimise interference between those signals.

The method may, in one example arrangement, comprise: selecting one of a plurality of device-to-device timing advance values to use in scheduling the transmission of said device-to-device signal; and scheduling the transmission of said device-to-device signal according to the selected device-to-device timing advance value.

Optionally, one of said plurality of device-to-device timing advance values may be associated with a first geographic area and another of said plurality of device-to-device timing advance values may be associated with a second geographic area. The method may, in this case, comprise determining which device-to-device timing advance value to select in dependence upon the geographic location of said wireless device.

Furthermore, one of said plurality of device-to-device timing advance values may be associated with a first channel and another of said plurality of device-to-device timing advance values is associated with a second channel. In this case, the method may comprise determining which device-to-device timing advance value to select in dependence upon the channel on which the device-to-device signal is to be sent.

Alternatively, or additionally, said device-to-device signal may be a periodic device-to-device discovery signal, and one of said plurality of device-to-device timing advance values may be associated with a first periodicity and another of said plurality of device-to-device timing advance values may be associated with a second periodicity. In this event, the method may comprise determining which device-to-device timing advance value to select in dependence upon the periodicity of said periodic device-to-device discovery signal.

In one example arrangement, a plurality of device-to-device timing advance values are received from a network control apparatus, and the method comprises indicating timing advance capacity information to the network control apparatus, said timing advance capacity information being for use by the network control apparatus in determining how many device-to-device timing advance values to send.

In one example arrangement, said wireless device is configured with at least one network timing advance value for use in scheduling uplink transmissions to a network control apparatus and said device-to-device timing advance value is dependent upon said at least one network timing advance value.

In one embodiment, said device-to-device timing advance value is for use in scheduling the transmission of a plurality of device-to-device signals for a predetermined period of time. In this arrangement, the method comprises discontinuing use of the device-to-device timing advance value after expiry of said predetermined period of time from the sending the first of said plurality of device-to-device signals.

According to a fifth aspect of the present disclosure, there is provided apparatus including a processing system for a wireless device, the apparatus being constructed and arranged to cause a said wireless device apparatus to: schedule the transmission of a device-to-device signal to a second wireless device according to a device-to-device timing advance value. The processing system may include at least one processor and at least one memory including computer program instructions, the at least one memory and the computer program instructions being configured, with the at least one processor, to cause the wireless device at least to perform a method as described above.

According to a sixth aspect of the present disclosure, there is provided a computer program comprising instructions such that when the computer program is executed on a user equipment, the user equipment is arranged to carry out a method a method as described above. There may be provided a non-transitory computer-readable storage medium storing a computer program as described above.

“Wireless devices” include in general any device capable of connecting wirelessly to a network, and includes in particular mobile devices including mobile or cell phones (including so-called “smart phones”), personal digital assistants, pagers, tablet and laptop computers, content-consumption or generation devices (for music and/or video for example), data cards, USB dongles, etc., as well as fixed or more static devices, such as personal computers, game consoles and other generally static entertainment devices, various other domestic and non-domestic machines and devices, etc. The term “user equipment” or UE is often used to refer to wireless devices in general, and particularly mobile wireless devices.

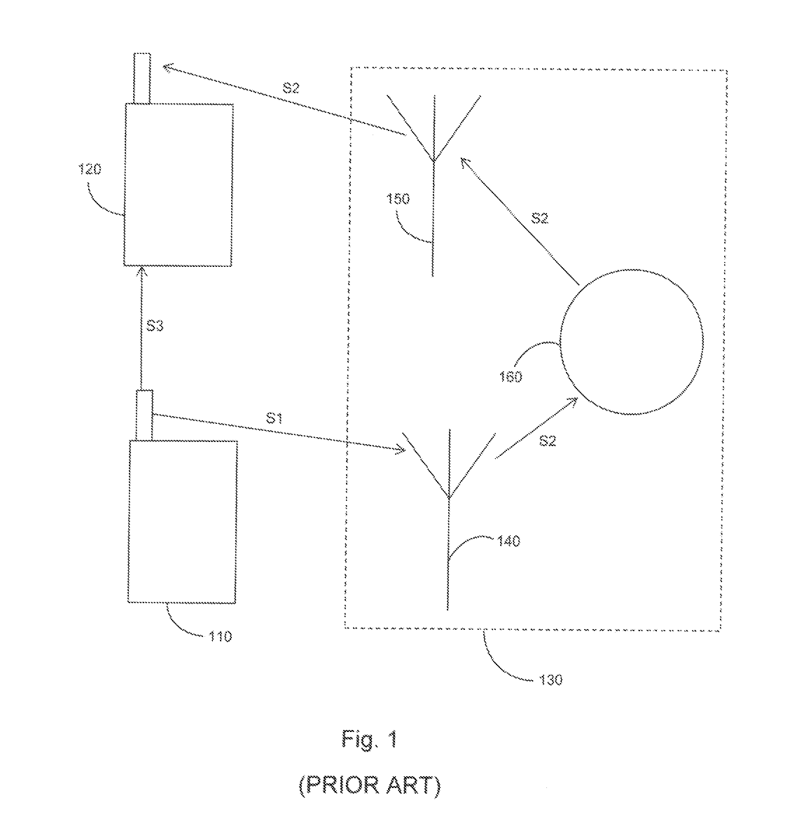

Prior art cellular networks typically comprise a number of geographically dispersed access nodes (such as Node Bs, Evolved Node Bs (eNBs), base stations and the like). Each access node typically provides service for a plurality of wireless devices that are each located within a cell associated with and serviced by the access node. FIG. 1 illustrates schematically part of a typical prior art cellular network communication system including first and second wireless devices 110,120 and a cellular wireless network 130, itself including two access nodes 140,150 and a network control apparatus 160 (it being understood that in practice, typically there will be many wireless devices being serviced by the cellular wireless network 130 at any one time). The first device 110 is in this example serviced by the first access node 140 and is therefore camped in a cell that is serviced by the first access node 140.

In wireless cellular systems such as the one shown, if the first wireless device 110 wishes to send a message to the second wireless device 120, the first wireless device 110 first sends a message to the first access node 140, as shown at S1. The cellular network 130 then routes the message to the second wireless device 120 as shown at S2. In this example, the second wireless device 120 is serviced by the second access node 150, and S2 comprises multiple transmissions. As an alternative, the second wireless device 120 may be serviced by the same access node 140 as the first wireless device 110, but messages between the first and second wireless devices 110, 120 still pass via the cellular network 130. Such a system of communication is in any event clearly burdensome on the network 130, particularly as typically many wireless devices need to route messages via the network 130 at any one time. With the increase in the number and capabilities of wireless devices, the burden on such cellular wireless networks is increasing and resources are becoming more and more stretched. There is, therefore, a need to reduce this burden by finding alternative ways for devices to communicate.

As mentioned above, as an alternative to communicating via a cellular network, it is possible for devices to communicate directly with one another in a so-called device-to-device (D2D) communication system. In such a D2D system, instead of sending a message via the cellular network 130, the first wireless device 110 can send messages directly to the second device 120, as shown by S3 of FIG. 1, and vice versa. In such a system, there is no need for a network (such as the cellular network 130) to process and route communications between the wireless devices and thus it has been proposed that D2D communications could be used to help reduce the burden on cellular networks by using D2D communication to provide some services that are currently provided by cellular networks. In addition, depending on the method of implementation, D2D communications may also help to cut down the power consumption of wireless devices (because often a lower transmit power will be required) and shorten the overall time taken to send signals between devices. Furthermore, D2D communications may make use of either a licensed frequency spectrum or an unlicensed frequency spectrum and, in the case that an unlicensed frequency spectrum is used, the heavy demand for resources in the licensed spectrum will be somewhat alleviated.

The accurate scheduling of the transmission of D2D signals is important, because devices engaging in D2D communication typically need to know when to expect reception of a D2D signal. Also, devices may be in receipt of D2D signals from a plurality of devices which, without adequate scheduling, may interfere with each other, leading to loss of information and/or increasing the processing required for error correction and the like. Furthermore, where D2D communications are used in a licensed frequency spectrum and separate resources are allocated for cellular and D2D communications, it is particularly important that the cellular signals and the D2D signals are appropriately scheduled such that they do not interfere with each other. This is particularly because the interference of D2D signals with cellular signals could lead to a lower quality cellular service and, more specifically, to loss of important control information sent by the network (which would not be acceptable to cellular users, or the cellular service providers).

Additionally, in relation to the transmission of discovery signals in particular (discussed in more detail below), it is advantageous if multiple wireless devices can be scheduled to broadcast discovery signals simultaneously. This is because wireless devices listening for discovery signals (hereinafter referred to as “receiving wireless devices”) are required to “wake up” in order to receive and decode discovery signals each time a wireless device transmits a discovery signal. If a plurality of wireless devices are scheduled to transmit discovery signals simultaneously, then a receiving wireless device need only wake up once to receive and decode the discovery signals transmitted by each of the plurality of transmitting wireless devices. Such an arrangement is clearly preferable from a power consumption perspective as opposed to, say, sporadic transmissions of discovery signals by the plurality of wireless devices, in which a receiving wireless device would be required to wake up multiple times (or stay awake continuously for an extended period of time) in order to receive each of the discovery signals.

Particular problems in the scheduling of the transmission of D2D signals arise when devices that are camped on different cells (and therefore may be synchronised with different access nodes) engage in D2D communications, because those devices will not be synchronised with each other, and thus there is no common reference frame that can be used to synchronise D2D transmissions.

Further to this, it has been realised by the inventors that, in order to provide a useful alternative to cellular communications, the distance over which devices can ideally communicate needs to be quite large; otherwise, the possible devices with which a wireless device can communicate will be limited. For commercial uses, it is estimated that ranges of a few hundred meters will be necessary. For public safety uses, the estimated required range is even greater, at around a few kilometres. However, signals take time to propagate between devices, the propagation delay depending on the distance between the devices, which is typically unknown. This adds a further layer of difficulty to the scheduling of D2D transmissions. By way of a contextual example, ranges of a few kilometres will incur a propagation delay of around 10 μs. This equates to a propagation delay of around 2 times the cyclic prefix length in LTE systems. Thus where D2D communications are implemented in an LTE system, the accurate scheduling of the transmission of D2D signals is clearly very important so as to avoid interference between the D2D signals and other signals.

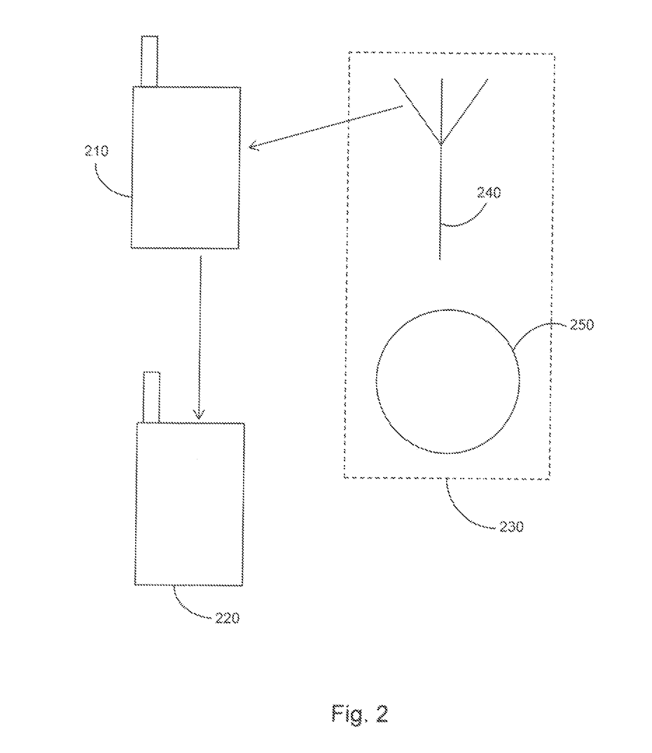

FIG. 2 shows schematically a first wireless device 210. The first wireless device 210 contains the necessary radio module, processor(s) and memorymemories, antenna, etc. to enable wireless communication with other wireless devices, such as the second wireless device 220 shown in FIG. 2. In one example, the first wireless device 210 is also able to communicate wirelessly with a wireless cellular network 230 as also shown in FIG. 2 and as will be described in more detail below.

In the present embodiment, the first wireless device 210 and the second wireless device 220 are configured to engage in device-to-device (D2D) communications with each other. They may make use of a licensed or an unlicensed spectrum, as described above. The first device 210 is configured with a D2D timing advance (TA) value for use in scheduling the transmission of a D2D signal to the second device 220. In one example arrangement, the D2D TA value is a value that enables the first device 210 to account or allow for the time taken for a signal to propagate from the first device 210 to the second device 220 when scheduling the transmission of the D2D signal, at least to some degree. In particular, where a D2D signal is to be received by the second device 220 within a particular time period (such as a timeslot), the D2D TA value tells the first device 210 how far in advance of that particular time period the D2D signal must be transmitted in order for the D2D signal to be received by the second device 220 within that time period. This is of particular benefit where the network 230 has allocated a particular time period as being for use by the second device 220 in receiving D2D signals.

Where a licensed spectrum is used for the D2D communication, the scheduling of the transmission of the D2D signal may depend both on the synchronisation between the first device 210 and the network 230, and the D2D TA value. As a particular example, where the first device 210 is synchronised with the uplink channel of an access node 240 of the network 230, and a particular uplink timeslot associated with the access node 240 (i.e. a timeslot running from t to t+T, where t is a time as measured by a clock that is synchronised with a clock of the access node 240) has been allocated as being for use by the second device 220 in receiving a D2D signal, the first device 210 may be configured to schedule the transmission of a D2D signal to the second device at t−T_{TA}, where T_{TA} is the D2D TA value in seconds.

In another example, the second wireless device 220 may instead be synchronised with the uplink channel of a second access node different from the access node 240, and may be allocated an uplink timeslot for use in receiving a D2D signal, which is associated with the second access node. In this case, the D2D TA value may be set such that any synchronisation difference between the access node 240 and the second access node is accounted for. The first wireless device 210 in this case would still apply the D2D TA value relative to a timeslot associated with the access node 240. Thus, the first wireless device 210 is able to schedule the transmission of a D2D signal to a second wireless device 220, which is not synchronised with the first device 210.

It will be appreciated that, although in the above examples, the first and second devices 210,220 are described as being synchronised with an uplink channel of an access node, the devices 210,220 could in general be synchronised with any channel(s), such as, for example, a downlink channel of an access node. In general, the first device 210 may apply its D2D TA value relative to a time frame of any channel with which it is synchronised.

In one example arrangement, the D2D TA value is set such that the transmission of the D2D signal is scheduled so that when it is received by the second device 220 it does not interfere with other signals being received by the second device 220. This is particularly useful if the first device 210 makes use of a licensed spectrum (e.g. a spectrum used by the network 230) for the D2D signals. This is because, as mentioned above, interference of a cellular signal with a D2D signal could lead to a lower quality of cellular service and, more specifically, the loss of important information, such as control information sent by the network 230, as discussed above. Moreover, the scheduling of D2D transmissions in such a way may allow for more efficient utilisation of resources because it allows the transmission of D2D signals to be more accurately scheduled and thus timeslots can be shorter without increasing the interference of signals on adjacent timeslots. This may be of particular benefit where the first device 210 makes use of an unlicensed spectrum, because there is greater flexibility in timeslot length and periodicity. The D2D TA value may, in one example, depend on the propagation delay between the first and second devices 210,220. Alternatively, or additionally, the TA value may depend on other factors, such as the synchronisation of at least one of the first and second wireless devices 210,220, with their respective serving access nodes. This allows D2D signals to be sent between unsynchronised wireless devices, as discussed above.

As will be discussed in more detail below, the D2D TA value may be configured by the first wireless device 210, or it may be configured by the network 230. Alternatively, the D2D TA value may be configured by both the first wireless device 210 and the network 230. For example, the D2D TA value may be initially configured by the network 230 and then may be adjusted dynamically by the first wireless device 210.

In one example arrangement, the first wireless device 210 may be configured to use the same TA value for all D2D communications. Alternatively, the first device 210 may be configured to use different TA values for different D2D communications, depending on the circumstances.

In one example arrangement, the first wireless device 210 may be configured with a plurality of D2D TA values and may be configured to select one of these D2D TA values for use in scheduling the transmission of a D2D signal depending on the circumstances. The D2D TA values may have one or more associations that enable the first device to select which D2D TA value to use. In one example arrangement, for example, each D2D TA value may be associated with a group of wireless devices (referred to herein as a D2D Timing Advance Group (dTAG), as will be discussed in more detail below), and the first wireless device 210 may select a D2D TA value by selecting a D2D TA value associated with a dTAG comprising the first device 210 and optionally also the device with which it wishes to communicate (i.e. the second device 220 in this example).

The D2D TA value may be explicitly associated with a group of devices making up a dTAG, or the association may be implicit. More specifically, one or more D2D TA values may be associated with a particular geographic area (such as a macro cell, micro cell, discovery area, or the like) and the first device 210 may determine which TA value to use for scheduling a D2D transmission to the second device 220 in dependence upon the geographic location of the first device 210 and, alternatively or additionally, in dependence upon the geographic location of the second device 220. In this case, a dTAG may be made up of those wireless devices that are located in a given geographic area and/or that are transmitting to devices within a given geographic area. As a specific example, the D2D TA values with which the first device 210 is configured may each be associated with a respective cell that is serviced by the wireless network 230, and the first wireless device 210 may be camped on a particular one of those cells. The first wireless device 210 may, in this event, select the D2D TA value associated with the cell in which it is camped to schedule a D2D transmission to the second device 220.

In one specific example, the plurality of the D2D TA values with which the first device 210 is configured may be for use by the first wireless device 210 when camped in a first cell and when transmitting a D2D signal to a wireless device that is camped in a different cell. In this case each of the said plurality of D2D TA values may be associated with both the first cell and a second cell, and may depend upon the difference in synchronisation between the access points serving those two cells. Thus, the first wireless device 210 may select a D2D TA value for use in scheduling a D2D transmission to the second device in dependence upon the cells in which the first and second wireless device 210,220 are camped. This allows D2D signals to be sent between wireless devices regardless of whether or not they are synchronised.

Additionally or alternatively, the D2D TA values may each be associated with different channels (e.g. uplink or downlink channels). As a particular example, the D2D TA value used in respect of an uplink channel may be different from the D2D TA value used in respect of a downlink channel and both D2D TA values may depend on the position of the transmitting wireless device in a given cell. This is useful, for example, where the first wireless device 210 is synchronised with a downlink channel, and is configured to apply D2D TA values relative to time frames of the downlink channel, but wishes to also use the uplink channel to transmit D2D signals.

As is known in the art, in order for the first device 210 to discover other wireless devices with which it may be able to engage in D2D communications (i.e. in order to find the second device 220, for example), the first device 210 may broadcast periodic D2D discovery signals commonly for receipt by all nearby wireless devices. In one example arrangement, the first device 210 may be configured with at least one D2D TA value that is for use in scheduling the transmission of such discovery signals.

The use of D2D TA values is of particular benefit in the scheduling of the transmission of discovery signals for a number of reasons. First, as discussed above, D2D TA values can be used to account for propagation delay between wireless devices. Secondly, it is desirable from a power-saving perspective for multiple wireless devices to transmit discovery signals simultaneously. This is because wireless devices listening for discovery signals (hereinafter referred to as “receiving wireless devices”) are required to “wake up” in order to receive and decode discovery signals each time a wireless device transmits a discovery signal. If a plurality of wireless devices are scheduled to transmit discovery signals simultaneously, then a receiving wireless device need only wake up once to receive and decode the discovery signals transmitted by each of the plurality of transmitting wireless devices. Such an arrangement is clearly preferable from a power consumption perspective as opposed to, say, sporadic transmissions of discovery signals by the plurality of wireless devices. However, as mentioned above, devices that are camped in different cells will not typically be synchronised (because they will typically be synchronised with different access points, which will not themselves be synchronised). In one example arrangement, therefore, D2D TA values may be set so as to account for the lack of synchronisation between wireless devices in different cells.

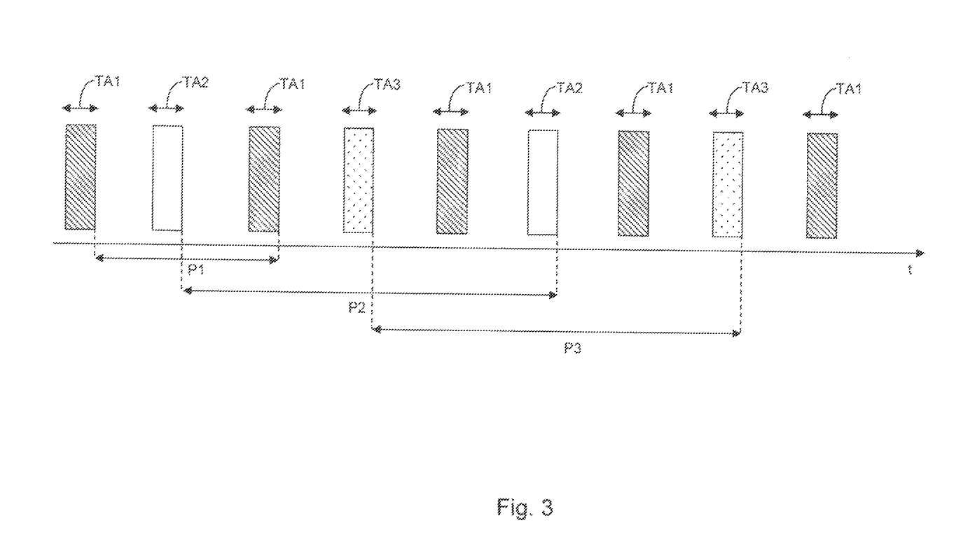

The first wireless device 210 may be configured with different D2D TA values for scheduling D2D discovery signals sent at different times. In one particular example arrangement, for example, one or more of the D2D TA values may be for use with a different discovery signal periodicity, and the first wireless device 210 may select a D2D TA value to use in scheduling the transmission of a D2D discovery signal to other wireless devices in dependence of the periodicity of that discovery signal. Thus, some D2D discovery signals having a first periodicity may be scheduled according to a first TA value and other D2D discovery signals having a second periodicity may be scheduled according to a second TA value. An example of such an arrangement is illustrated schematically in FIG. 3. In this example, the first device 210 is configured to transmit D2D discovery signals with a first periodicity P1. Each of these D2D transmissions is scheduled according to TA value TA1. The first device 210 is further configured to transmit D2D discovery signals with second and third periodicities P2 and P3 respectively. The D2D discovery signals with periodicities P2 and P3 are scheduled according to TA values TA2 and TA3 respectively. In this example, the TA values TA1, TA2 and TA3 correspond to a length of time, which tells the first device 210 how far in advance of the beginning of the relevant occasion to transmit the D2D discovery signal.

As is known in the art, different D2D discovery signals may be transmitted with different ranges (i.e. covering different distances). In other words, a D2D discovery signal with a first range may be received by devices within a first distance from the first device 210. Similarly, a discovery signal with a second range may be received by devices within a second distance from the first device 210. The area in which wireless devices may be able to receive discovery signals transmitted by a wireless device with a particular range is known as a discovery area. Thus, the larger the range of a D2D signal, the greater the discovery area. In one example arrangement, the different D2D TA values for use in scheduling the transmission of discovery signals at different times may be associated with different discovery signal ranges. Thus, if the first wireless device 210 needs to schedule the transmission of a first discovery signal having a first range, the first wireless device 210 may schedule the transmission according to a first TA value associated with that first range. If the first wireless device 210 then, at another time, needs to schedule the transmission of a second discovery signal having a second range, the first wireless device 210 may schedule the transmission according to a second TA value associated with that second range.

In one specific example, the first device 210 is configured with plural TA values, such as first, second and third D2D TA values, those D2D TA values being associated with plural periodicities, such as in this case first, second and third periodicities respectively. In this example, the first, second and third D2D TA values are associated with different discovery range classes (in this case “short”, “intermediate” and “long” discovery range classes respectively). A discovery range class may include a spectrum of discovery signal ranges (i.e. a discovery range class may correspond to a range of discovery areas having sizes between a first size and a second size). The first device 210 may, therefore, schedule the transmission of discovery signals having the first periodicity according to the first D2D TA value. The first device 210 will set its transmit power such that the range of those discovery signals falls within the “short” discovery signal range class. Similarly, the first device may concurrently schedule the transmission of discovery signals having the second and third periodicities according to the second and third D2D TA values respectively. In each case, the first device 210 will set its transmit power such that the range of those discovery signals falls within the “intermediate” or “long” discovery signal range classes as appropriate. In this case, the first second and third D2D TA values may depend upon any synchronisation differences between the access node 240 serving the first device 210 and nearby access nodes serving devices within the associated discovery signal ranges.

As mentioned above, the first device 210 may be able to communicate wirelessly with the cellular network 230 illustrated schematically in FIG. 2. The wireless cellular network 230 shown in FIG. 2 includes a network access node 240 and a network control apparatus 250. The network control apparatus 250 may be separate from the network access node 240 (as illustrated schematically in FIG. 2). In the context of UMTS (Universal Mobile Telecommunications System), for example, the network control apparatus 250 may be provided by a so-called Radio Network Controller, and the access node may be provided by a NodeB. Alternatively, the network control apparatus 250 may be integrated with the network access node 240. In the context of LTE, for example, the network access node 240 and the network control element 250 are integrated within an eNB (Evolved Node B).

In one example embodiment of the present disclosure, the network 230 is configured to determine the value of a D2D TA value for use by the first device 210 in scheduling the transmission of a D2D signal to the second device 220 and then indicate, via the network access node 240, that value to the first device 210. In other words, in this embodiment, the D2D TA value for the first device 210 is configured by the network 230. Additionally the network 230 may be connected to other wireless devices, and the network control apparatus 250 may be configured to determine one or more D2D TA values for use by those devices in scheduling D2D transmissions. The network 230 may then indicate those values to the devices via the network access node 240 or another access node of the network 230.

In this embodiment, the network 230 is therefore able to maintain control over the scheduling of D2D transmissions of wireless devices connected to the network 230 and can coordinate the transmissions (both cellular, and D2D) of multiple devices. This is particularly advantageous in the case that the D2D communication between the first device 210 and the second device 220 makes use of the same frequency spectrum as is used by the cellular network 230. This is because the cellular network 230 can set a D2D TA value that will cause the first wireless device 210 to schedule the transmission of the D2D signal so as to avoid interference with other signals received by the second device 220. Thus the cellular network 230 can ensure that the quality of the cellular service provided by the cellular network 230 is not affected by interference between D2D and cellular communications, or at least such that any interference is minimised, as discussed above. The cellular network 230 may determine the value of the D2D TA value in dependence upon the propagation delay between the first and second device 210,220, although it will be appreciated that other factors may, in addition, or as an alternative, be taken into account, such as synchronisation differences between nearby access nodes.

In one example arrangement, the D2D TA value may be indicated to the first device 210 via dedicated signalling between the first device 210 and the network 230. Where the network 230 is an LTE network, such dedicated signalling may be RRC (Radio Resource Control) signalling for example.

Alternatively, the D2D TA value may be indicated to the first device 210 via common signalling between the first device 210 and the network 230 (i.e. signalling that is broadcast commonly to a group of wireless devices, such as System Information, for example). In this case, all devices in receipt of the common signalling will be configured with that D2D TA value. This is useful in the case that the network 230 determines that a particular D2D TA value is suitable for use by a plurality of wireless devices, because the network 230 is able to configure those wireless devices with that D2D TA value by sending a single message, which is far less burdensome on the network 230 than sending multiple dedicated signals. A particular TA value may be suitable for all devices within a particular geographic area, such as cell, micro cell or discovery area, for example, or as another example, a particular TA value may be suitable for all wireless devices using a particular channel (e.g. an uplink or downlink channel) to transmit D2D signals. The network 230 may indicate the geographic area and/or channel for which the D2D TA value is suitable. Thus, if the first device 210 is configured with other D2D TA values, the first device 210 is able to determine which D2D TA value to use, as described above. As mentioned above, the wireless devices for which a particular D2D TA value can be used make up a dTAG.

In one example arrangement, the network 230 may determine a number of D2D TA values for a number of associated dTAGs and may broadcast an index of dTAGs and associated D2D TA values to a plurality of wireless devices. The index may be sent to all connected wireless devices within a particular cell, for example. As discussed above, the first wireless device 210 may be configured to identify the dTAG in which the first device 210 (and optionally also the second device 220) falls and to use the associated D2D TA value. Indicating D2D values to wireless devices in such a way further reduces or minimises the burden on the network 230, as a plurality of wireless devices can be configured with a plurality of different D2D TA values (and their associated usage cases) via a single message.

As mentioned above, the first device 210 may be configured with at least one D2D TA value that is for use in scheduling the transmission of at least one discovery signal. On the network side, therefore, the network 230 may determine D2D TA values for use in scheduling the transmission of discovery signals differently from the method by which D2D TA values for use in scheduling the transmission of “normal” D2D signals (i.e. D2D signals sent between two particular devices that have already discovered one another) are determined. For example, the network 230 may set the D2D TA value for the first device 210 such that the first device 210 is configured to transmit discovery signals at the same time as other wireless devices.

In one example arrangement, the network 230 may determine that a particular D2D TA value is suitable for use in scheduling the transmission of all discovery signals with a particular periodicity. In this case, all wireless devices that have the capacity to transmit with that periodicity make up a dTAG (which is associated with the determined D2D value). The network 230 may do this for a plurality of discovery signal periodicities, and may indicate those periodicities and the associated D2D TA values to the first device 210 in index form. The index may be indicated commonly to a plurality of wireless devices connected to the network 230.

In one example arrangement, the wireless network 230 may determine one or more D2D TA values which are suitable for scheduling the transmission of discovery signals over a particular range (i.e. distance), or falling within a particular range class (as described above). In this case, all wireless devices that have the capacity to transmit with that discovery signal range (or a range falling within that particular discovery signal range class) make up a dTAG. The network 230 may do this for a plurality of discovery signal ranges (or range classes), and may indicate those ranges and the associated D2D TA values to the first device 210 in index form. The index may be indicated commonly to a plurality of wireless devices connected to the network 230.

Alternatively or additionally to the above, the network 230 may determine at least one D2D TA value that is suitable for use in a particular discovery area. As described above, a discovery area is an area in which all wireless devices listening for D2D discovery signals can receive a D2D discovery signal sent by a particular wireless device. In this case, all wireless devices that are located within that particular discovery area make up a dTAG. As in the above examples, the network 230 may determine D2D TA values for use in respective ones of a number of different discovery areas, and may indicate an index of the D2D TA values and their associated discovery areas, either directly or commonly, to one or more wireless devices connected to the network 230.

In one example arrangement, the network 230 may indicate at least one D2D TA value to the first device 210 via dedicated signalling, and at least one other D2D TA value may have been indicated via common signalling. In one example arrangement, the first device 210 may be configured to select a D2D TA value that has been received via dedicated signalling in preference to a D2D TA value that was received via common signalling. If the first device 210 has not received an indication of a D2D TA value via dedicated signalling, it may be configured to select one of the D2D TA values received via common signalling. This has the advantage that, in the event that the network 230 has determined that a common D2D TA value is suitable for all devices within a particular area (e.g. cell) in which the first device 210 is located, but has determined that a second D2D TA value would be more suitable than the common D2D TA value for the first device 210, the network can indicate the common D2D TA value to all devices within the particular area (including the first device 210) via common signalling and also indicate the second D2D TA value to the first wireless device 210 via dedicated signalling. Thus the network 230 does not need to dedicatedly signal the D2D TA value for each wireless device in that area and can instead configure most D2D TA values by sending a single common signal, thereby minimising the overall number of signals the network 230 needs to send.

In one example embodiment, the first device 210 may send timing advance capacity information to the network 230. Such timing advance capacity information may include the maximum number of TA values the first wireless device 210 can simultaneously support. The network 230 may take account of this information when indicating D2D TA values to the device 210. Additionally or alternatively, the timing advance capacity information may include one or more of: the channels the first device 210 can use and the discovery periods the device 210 can support. The network 230 may take all of these factors into account when determining which D2D TA values to indicate to the first device. For example, the network may only send the D2D TA values that are applicable to the first device 210 e.g. the network 230 may not send D2D TA values that are associated with channels that the first device 210 cannot use.

In one example embodiment, at least one D2D TA value indicated to the first device 210 by the network 230 is associated with a validity time T. In this case, the first wireless device 210 may use that D2D TA value up to that validity time Tᵥ only. Beyond that time, the D2D TA value becomes invalid and cannot be used by the first device 210. Thus, upon receipt of a the D2D TA value, the first device 210 may start a timer, and when the time reaches Tᵥ the first device 210 may be configured to discontinue use of that D2D TA value. In one example arrangement, where the D2D TA value is associated with a particular channel, the first device 210 may not be able to send D2D communications on that channel until it obtains a new D2D TA value for that channel. The validity time Tᵥ may be a fixed value and may, for example, be stored in a memory of the first device 210. In this case, all D2D TA values received for the network 230 may only be valid for the fixed validity time Tᵥ. Alternatively the validity time Tᵥ may be different for different D2D TA values and the network 230 may send an indication of the validity time Tᵥ for a particular D2D TA to the first device 210. At any time, the network 230 may instruct the device 210 to discontinue use of a particular D2D TA value regardless of whether its validity has expired. Additionally, or alternatively, the network 230 may update the value of the validity time Tᵥ regardless of whether the original validity time has expired.

As is known in the art, some wireless devices are subject to clock drift. As will be appreciated, for such devices, the suitability of a D2D TA value will decrease with time, as the clock of the wireless device drifts. Thus, one advantage of configuring a wireless device with a D2D TA value having an associated validity time is that the D2D TA value can be set to “expire” before the suitability of the D2D TA value depreciates beyond a certain point. Upon expiration of a device-to-device timing advance value, a wireless device may be required to “re-synchronise” by receiving a new device-to-device timing advance value from the network, which takes into account the amount by which the clock of the wireless device has drifted since the last device-to-device timing advance value was configured.

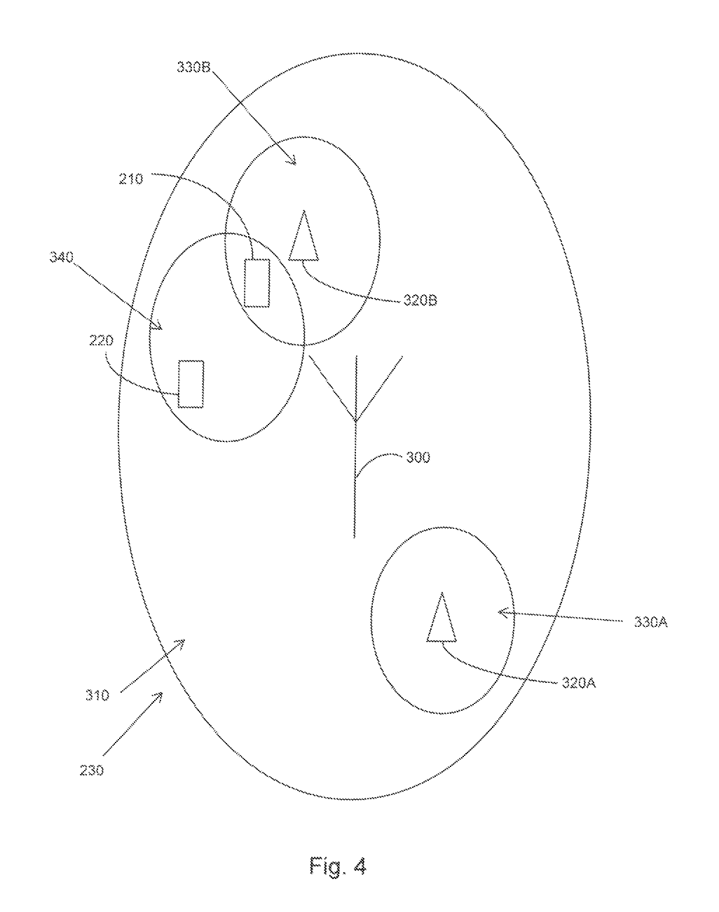

FIG. 4 shows a specific example of an environment in which an example embodiment of the present disclosure may be practised. The network 230 is a 3GPP LTE network, which includes an eNB 300, which serves a primary cell (PCell) 310, and a number of remote radio heads (RRH) 320A,320B, each serving a secondary micro-cell (SCell) 330A,330B. The eNB 300 provides the functionality of the access node 240 and the network control apparatus 250, as described above in relation to FIG. 2.

The PCell 310 is the primary serving cell for both the first and second devices 210,220, and thus both devices 210,220 receive their control information from the eNB 300. The first device 210 is located within micro-cell 320B, and thus can receive cellular communications both from the eNB 300 and the RRH 320B.

As is known in the art, in such a network 230, for all wireless devices for which the cell 310 is the primary serving cell, the eNB 300 determines one or more cellular timing advance (TA) values for use by the wireless devices in scheduling the transmission of uplink cellular communications to the network 230. Such cellular TA values allow those devices to account for the propagation delay of signals sent from the device to a network access point of the network 230 (e.g. eNB 300 or RRH 320A,320B) when sending messages to the network 230. The eNB groups any cells that have the same TA value together to form a Timing Advance Group (TAG), and forms an index of TAGs against associated cellular TA values.

In this example, for the first device 210, the eNB 300 may determine a first cellular TA value for use in scheduling transmissions to the eNB 300 and a second cellular TA value for use in scheduling transmissions to the RRH 320B. If there were another SCell for which the second cellular TA value is applicable, the eNB 300 would group that SCell with SCell 330B to form a TAG.

The network 230 would then indicate an index of TAGs against associated cellular TA values to the first wireless device 210 via the MAC (Medium Access Control) CE (control element), and the first device 210 would select the appropriate cellular TA value for scheduling cellular transmissions depending on the cell it is using. For example, if the first device 210 wishes to send a signal to the eNB 300, the first device 210 identifies the cellular TAG that includes the PCell and uses the associated cellular TA value to schedule a transmission to the eNB 300. If the first device 210 wishes to send a signal to the RRH 320B, on the other hand, the first device 210 identifies the cellular TAG that includes the SCell 230B and uses that associated cellular TA value to schedule transmissions to the RRH 220B. The TAG containing the PCell is known as the pTAG, and all other TAGs are known as sTAGs.

In the present version, an eNB of the network 230 may be configured to determine one or more D2D TA values for use by the first device 210 in scheduling the transmission of D2D signals to other wireless devices as described above in relation to FIG. 2. The one or more D2D TA values may be determined by the eNB 300 (which as explained above is the eNB that provides control information for the first device 210) or, alternatively, the one or more D2D TA value may be determined by an eNB associated with a cell in which a D2D communication is to take place.

In the case that one or more D2D TA value is indicated to the first device by the eNB 300, the eNB 300 may indicate the D2D TA value(s) to the first device at the same time that it indicates the cellular TA value(s) to the first device 210. In other words, the eNB 300 may indicate the determined D2D TA value(s) to the first device in a MAC CE. Any associations with the one or more D2D TA values may also be indicated to the first device 210 at this time.

The network 230 may indicate a D2D TA value to the device 210 irrespective of whether that D2D TA value is the same as any of the cellular TA values. This has the advantage that the network 230 can easily alter a cellularD2D TA value without having to re-indicate the other TA values. The network 230 may alter a TA value via dedicated signalling. A particular index may be reserved for this purpose. At least one of the D2D TA values indicated by the network may depend upon at least one of the cellular TA values. For example, the difference between a D2D TA value and a cellular TA value may not be allowed to exceed a certain value. For discovery signals in particular, the network 230 may determine large D2D TA values for wireless devices that have large cellular TA values, and smaller D2D TA values for wireless devices that have smaller cellular TA values.

As a particular example, where the first device 210 wishes to send a D2D message to the second device 220, the eNB 300 is configured to determine a D2D TA value for use in scheduling such a communication. The D2D TA value may be determined in dependence upon the propagation delay between those wireless devices 210,220 (as well as any limitations on the D2D TA value relative to any cellular TA values as discussed above).

In a particular example arrangement, the eNB 300 may also determine a number of other D2D TA values for use by other connected wireless devices in scheduling the transmission of D2D communications at this stage. Where possible, the eNB may then group all wireless devices for which a particular D2D TA value is applicable together to form one or more dTAGs. In this example, the D2D TA value for use by the first device 210 in scheduling transmissions to the second device 220 is at least applicable to the first device 210 and the second device 220, and thus the first and second devices 210,220 fall within a dTAG 340, as illustrated schematically in FIG. 4. Other wireless devices may also fall within this dTAG. As discussed above, the wireless devices making up a dTAG may be implicit if, for example, the associated D2D TA value is for use by devices in a particular cell. The eNB may then indicate an index of dTAGs and associated TA values to the first wireless device 210 and the first device 210 may select the TA value associated with dTAG 340 to schedule a transmission to the second device 220.

As discussed above, the first device 210 may have a maximum number of TA values that it can support, and the number of cellular TA values with which the device 210 has (or will be) configured may also be taken into account when determining which and how many D2D TA values the first device 210 should be configured with.

As also discussed above, at least one D2D TA value may be associated with a validity time Tᵥ which sets the length of time for which a D2D TA value may be valid. It is known in the art that cellular TAGs may themselves be associated with a validity time, and the D2D TA value validity time may be shorter, longer or equal to any of the validity times associated with the cellular TAGs. The first device 210 may be configured to run multiple TA timers independently, and a timer monitoring the validity of a D2D TA value may be kept running after the expiry of a cellular TA value. Thus, where a D2D TA value is associated with a particular channel, the first device 210 may be able to use that channel for D2D communications, but not for cellular communications if the cellular TA value for that channel has expired.

Alternatively, upon expiry of a cellular TA value (and in particular, upon expiry of the TA value associated with the PCell), the first wireless device 210 may be configured to discontinue use of one or more D2D TA values and to stop the clock(s) associated therewith. Alternatively, the first wireless device 210 may be configured to suspend use of one or more D2D TA values until a new cellular TA value has been obtained.

In one example arrangement, where the first wireless device 210 has only one TA clock, the first wireless device 210 may be configured to discontinue use of all D2D TA values when the validity of the cellular TA value for the PCell expires. In one example arrangement, the first device 210 is configured to store a D2D TA value in a memory of the device 210 once that value has expired. Thus, if the network 230 determines that a D2D TA value that has expired can be used again, the network 230 need not reconfigure the first device 210 with that D2D TA value, but need only indicate to the first device 210 that the old D2D TA value is still valid.

The above embodiments are to be understood as illustrative examples of the invention. Further embodiments of the invention are envisaged. It is to be understood that any feature described in relation to any one embodiment may be used alone, or in combination with other features described, and may also be used in combination with one or more features of any other of the embodiments, or any combination of any other of the embodiments. Furthermore, equivalents and modifications not described above may also be employed without departing from the scope of the invention, which is defined in the accompanying claims.

1. A method of operating a network control apparatus, the network control apparatus being wirelessly connected to at least a first wireless device, the method comprising:
the network control apparatus indicating a device-to-device timing advance value to the first wireless device, the device-to-device timing advance value being for use by the first wireless device in scheduling the transmission of a device-to-device signal to a second wireless device.

2. The method according to claim 1, wherein said device to device timing advance value is dependent upon the propagation delay fbr transmission of a signal between the first and second wireless devices.

3. (canceled)

4. The method according to claim 1, comprising the network control apparatus indicating a plurality of device-to-device timing advance values to the first wireless device.

5. (canceled)

6. The method according to claim 4, wherein at least two of said plurality of device-to-device timing advance values are for use in scheduling the transmission of periodic device-to-device discovery signals, one of said at least two device-to-device timing advance values being associated with a first device-to-device discovery signal periodicity, and another of said at least two device-to-device timing advance values being associated with a second device-to-device discovery signal periodicity.

7-14. (canceled)

15. An apparatus for operating a network control apparatus comprising a processing system, the processing system comprising at least one processor and at least one memory storing computer program instructions, the apparatus being constructed and arranged to cause a said network control apparatus to:
indicate a device-to-device timing advance value to a first wireless device wirelessly connected to the network control apparatus, the device-to-device timing advance value being for use by said first wireless device in scheduling the transmission of a device-to-device signal to a second wireless device.

16. The apparatus according to claim 15, wherein said device to device timing advance value is dependent upon the propagation delay for transmission of a signal between the first and second wireless devices.

17. The apparatus according to claim 16, wherein said device to device timing advance value is dependent upon a first time frame with which the first device is synchronized, and a second time frame with which a different wireless device is synchronized.

18. The apparatus according to claim 15, arranged to cause the network control apparatus to indicate a plurality of device-to-device timing advance values to said first wireless device.

19. The apparatus according to claim 18, wherein each device-to-device timing advance value is at least one of: (i) for use within a particular geographic area and (ii) for use on a particular channel.

20. The apparatus according to claim 18, wherein at least two of said plurality of device-to-device timing advance values are for use in scheduling the transmission of periodic device-to-device discovery signals, one of said at least two device-to-device timing advance values being associated with a first device-to-device discovery signal periodicity, and another of said at least two device-to-device timing advance values being associated with a second device-to-device discovery signal periodicity.

21. The apparatus according to claim 20, arranged to cause the network control apparatus to indicate said first and second associated periodicities to said first wireless device.

22. The apparatus according to claim 18, wherein the number of device-to-device timing advance values indicated to said first device is dependent upon timing advance capacity information received from said first wireless device.

23. The apparatus according claim 15, arranged to cause the network control apparatus to indicate at least one device-to-device timing advance value to said first wireless device via dedicated signalling between the network control apparatus and said first wireless device.

24. The apparatus according to claim 15, wherein the apparatus is arranged to cause the network control apparatus to indicate at least one device-to-device timing advance value to plural wireless devices via common signalling.

25. The apparatus according to claim 15, wherein the network control apparatus is caused to indicate a common device-to-device timing advance value to a plurality of wireless devices wirelessly connected to the network control apparatus and forming a device-to-device timing advance group.

26. The apparatus according to claim 15, wherein the device-to-device timing advance value is dependent upon values of one or more network timing advance values which are for use in scheduling uplink transmissions from said wireless device to the network.

27. The apparatus according to claim 15, arranged to indicate to said first device a period of time for which said device-to-device timing advance value is to be used by the first wireless device in scheduling the transmission of one or more signals to other wireless devices.

28. The apparatus according to claim 15, wherein the network control apparatus is part of an LTE network provided by an eNB.

29-55. (canceled)

56. An apparatus for operating a wireless device comprising a processing system, the processing system comprising at least one processor and at least one memory storing computer program instructions, the apparatus being constructed and arranged to cause t-said wireless device to:
schedule the transmission of a device-to-device signal to a second wireless device according to a device-to-device timing advance value.

57-59. (canceled)

60. The apparatus according to claim 56, further arranged to cause the wireless device to select one of a plurality of device-to-device timing advance values to use in scheduling the transmission of said device-to-device signal, and to schedule the transmission of said device-to-device signal according to the selected device-to-device timing advance value.

61-81. (canceled)
